(19) United States
(12) Patent Application Publication
(10) Pub. No.: US 2005/0019215 A1
(43) Pub. Date: Jan. 27, 2005

(54) Measuring probe for detecting agents and the measurement of their concentrations

(76) Inventors: Gerlinde Bischoff, Halle/Saale (DE); Robert Bischoff, Halle/Saale (DE)

Correspondence Address: STRIKER, STRIKER & STENBY, 103 East Neck Road, Huntington, NY, 11743, US

(21) Appl. No.: 10/892,666

(22) Filed: Jul. 16, 2004

Related U.S. Application Data
(63) Continuation-in-part of application No. 09/806,736, filed on Apr. 4, 2001, now Pat. No. 6,767,747.

(30) Foreign Application Priority Data
Dec. 10, 1998 (DE) 198 56 885.1

(51) Int. Cl. G01N 21/00

(52) U.S. Cl. 422/58

(57) ABSTRACT

The measuring probe (1) for detecting agents in a gaseous medium and/or liquid medium and/or for measuring their concentrations includes a non-analyte-specific sensor-active solid layer (4) which reacts to adsorption of agent molecules on it from a gas or a liquid medium by changing its electrical properties, but which is not analyte-specific, does not absorb the agent molecules into the solid layer (4) and does not react chemically with any agent molecules within the solid layer (4); a liquid covering film (7) on the sensor-active solid layer (4) formed from the gas or consisting of a selected liquid, which is arranged between the gas or liquid medium and the sensor-active solid layer (4), so as to cover the sensor-active solid layer (4) and a plurality of electrodes (2) arranged in contact with the sensor-active solid layer (4) for electrical measurement of changes in electrical properties of the sensor-active solid layer (4) due to presence of agent molecules in the gas or liquid medium.

### CROSS-REFERENCE

This is a continuation-in-part of U.S. patent application Ser. No. 09/806,736, filed Apr. 4, 2001, which has issued as U.S. Pat. No. 6,767,747, on Jul. 27, 2004.

### BACKGROUND OF THE INVENTION

The subject matter of the present invention includes a measuring probe of a measuring device for detecting agents in gases and/or liquids and for measuring their concentrations. To do this, the measuring device uses changes in electrical characteristics. To conduct the measurements, the agents to be tested are placed in contact with a surface of the measuring device. The agent changes the conductivity, depending on its nature and its concentration, of the surface of the measuring device.

It is known that the concentration of various agents can be determined with the aid of resistance measurements. For example, the international patent classification (IPC), G01N 27/00, describes analysis of materials through the application of electrical methods. Under G01N 27/12 special resistance studies are considered, which describe changes in the resistance of a solid due to absorption of a liquid. Measuring probes with electrodes are used to do this, which are described in G01 N 27/07.

It is also known that such measuring probes of measuring devices consist of two suitably formed electrodes, which are attached to a support, and that the conductivity of a suitable substance between these electrodes is determined as an indirect measurement variable for determining the agent concentration to be measured. Depending on the detected agents, various often specially optimized substances are used, on which these agents are adsorbed. In addition, the substance itself also has a certain electrical conductivity, which is changed by the adsorption and physical combination of agents serving as an adsorbate. Organic and inorganic semiconductor materials are used as suitable substances for this purpose, since the relative change of the conductivity due to the adsorption of these agents is sufficiently large. For various agents, both narrowband and broadband selectively acting substances are known. The change of the electrical conductivity serves to determine the concentration since there is a monotonic relationship between the concentration and the conductivity in the applicable measurement range. It is possible to use an oscillating field for the measurement of the electrical conductivity change and to apply its additional parameters, such as specific complex loss angle, as an additional aid for the evaluation.

By using a suitable design of the electrodes, the usable conductivity range can be represented by a suitable conductance of the measuring probe. By means of a suitable structure of the surface, such as pores, between the electrodes, the proportional influence of the adsorption on the part of the substance used for the measurement can be changed. The adsorption time is determined, in particular, by the type of substance layer and the substance temperature.

A number of such measuring probes for determining concentrations of various agents in gases are manufactured with organic semiconductor material, preferably polymers, on ceramic supporting materials. Due to the high humidity and the high surface tension of water, the substances of such measuring probes are coated with a thin water film in a normal climate. Due to its own conductivity, this results in a total conductivity of the measuring device, which is about one magnitude above that of the substances used. In order to prevent an incorrect measurement due to the absorption of water, such measuring probes are equipped with a heating element or a separate heating unit, which heats the substance so that the moisture film evaporates completely. These measuring probes necessarily function with higher temperatures compared to the surroundings and primarily above 150° C. The useful measurement range, with respect to the concentration of the agents, normally runs from a minimum of 1 part per million (ppm) to a saturation concentration of the agent being determined. Within this measurement range and with increasing concentration, there is a monotonically increasing conductance of the measuring probe, which, based on previous calibration, can be converted into the concentrations of the agent being measured.

The disadvantage of such sensors is the relatively low sensitivity to very low concentrations of certain agents in gases and the requirement for heating. Due to this, such measuring probes are more complex and more expensive to manufacture and to operate. In addition, the use of these sensors in the ambient temperature range, for example in a normal climate, is limited.

EP 0 328 108 A3 describes an electrochemical sensor for measurement of the concentration of a chemical substance in a solution, in which two field-effect transistors (FET) and a reference electrode are arranged on a substrate. A hydrogel as an “electrode” is arranged above the region of the channel between one of the FETs and the reference electrode and enzymes are used for substance detection, which activate the FET through the change of the conductivity in the electrode. The detection of the type and concentration of the substance in the solution is done by means of an evaluation of the signal from the FET.

This sensor can only be used for the determination of relatively high concentrations in the range of a few parts per million of substances in solutions, but agents in gases cannot be determined satisfactorily with this method. The concentrations of only a few selected substances can be determined in this manner. In addition, the hydrogel for the sensor can be easily and irreversibly contaminated with substances disturbing the measurement and this makes the sensor unusable. Due to the microstructures, expensive technologies from the microelectronics area are needed to manufacture such sensors.

The disclosures in WO 89/08713 reveal a method and a device for determining the concentration of certain body fluids. A fluid sample is placed in a sample cell with two electrodes and mixed with an oxidizing agent and a buffer as a redox-system and then the conductivity is read from an ammeter and an evaluation unit. The display unit shows the concentration of the substance in the body fluid. The conductivity of the sample fluid is also used to turn on the measuring device.

The disadvantage of this method is the limitation to liquids, the relative insensitivity with a lower detection range in a concentration of ppm and the arrangement of a reference electrode in the sample cell. This is a further development of the measurement arrangement for the determination of the conductivity of liquids.

An analyte selective sensor for qualitative and/or quantitative determination of ions or substances contained in solutions is described in U.S. Pat. No. 6,004,442. This analyte selective sensor consists of at least one layer, which is in contact with the solution and which is applied to an inert supporting material. This layer is analyte specific and consists of a liquid, solid or semi-solid material and is in contact with at least two electrodes. The layer selectively removes the analyte from the solution so that the absorption of the analyte changes the electrical characteristics of the layer, such as the resistance, conductivity, admittance or the impedance. This analyte-specific layer, as a polymer membrane layer, is doped with specific, ion-selective or molecule-selective coupling elements, which extract the specific analyte from the solution through this polymer membrane layer. Of necessity, the analyte-specific layer must be designed in advance of the measurements for the specific agent to be determined by means of the special coupling elements. This will result in a sensor, which can only be used for a certain agent and which must be known before the manufacture of the sensor. However it is a disadvantage that measurements can only be made in liquids. Furthermore due to the particular coupling elements used irreversible analyte extractions or combinations with the layer, so that changes in agent concentration can no longer be determined during the measuring period. Because of the irreversible analyte extractions or combinations, the sensor is usable as a dosimeter but not applicable for long-term measurements for continuously monitoring concentrations of certain agents in gases and/or liquids.

### SUMMARY OF THE INVENTION

The purpose of the invention is to develop a sensitive measuring probe, without the above disadvantages, for the detection of agents and measurement of their concentrations in gases and/or liquids under the most varied of real measuring conditions without additional expenditure and without a heating element.

This object is attained according to the invention with a measuring probe for detecting agents in a gaseous and/or liquid medium and/or for measuring concentrations of said agents, which comprises
a non-analyte-specific sensor-active solid layer that reacts to adsorption of agent molecules on a sensor-active solid layer from a gas or a liquid medium by changing electrical properties of the sensor-active solid layer, but which is not analyte-specific, does not absorb the agent molecules into the solid layer and does not react chemically with any of the agent molecules within the solid layer;
a liquid covering film on the sensor-active solid layer formed from the gas or consisting of a selected liquid, which is arranged between the gas or liquid medium and the sensor-active solid layer, so as to cover the solid layer; and
a plurality of electrodes arranged in contact with the sensor-active solid layer for electrical measurement of changes in the electrical properties of the solid layer due to presence of agent molecules in the gas or liquid medium.

The essence of the invention is that a measuring probe in the form of a dipole is used to determine the electrical resistance of a sensor-active solid layer, in which a covering film of a liquid, such as water, is purposely included in the active zone of the measuring probe. The covering film forms over the substance of the sensor-active solid layer. Based on the covering film, a combination of various partial conductances is available. In particular these are the conductances for the substance, the covering film and for the active surface, which forms between both of these. Molecules of the covering film also serve as an adsorbate for the agent to be determined in the gas or liquid, in addition to the substance. The adsorption characteristics for certain agents can be optimized by the systematic selection of the liquid for the covering film.

The probe operates basically under saturated conditions with respect to the adsorption of the liquid in the diffusion layer. In its basic condition (0% agent+liquid in saturation) there is a comparatively high conductance. The presence of certain agents, depending on the type, results in a hindrance or promotion of mobile charge carriers and/or reduces or increases the number of the mobile charge carriers. In this manner, the smallest traces of the gas to be detected have an exponential effect on the electrical conductivity of the measuring probe and reduce or increase the conductivity drastically. A reversible doping effectively occurs on the surface of the measuring probe. This effect occurs even with relatively small concentrations of the agent to be detected and is reinforced with increasing concentration of the agent. With an increasing concentration of the agent, this results in a decreasing or increasing differential conductance of the measuring probe with respect to the basic condition. This conductance can, according to the invention and assuming prior calibration, be used for the calculation of the concentration of the agent to be found. To do this an equivalent circuit diagram for the sensor is used, which represents it as an electrical dipole. The complex equivalent variables required for the description in the measurement window correlate primarily with the resistances and the thickness of the individual layers.

The advantages of the invention particularly include the greater sensitivity compared to measuring probes without a covering film over the substance, by at least two powers of ten. Thus the detection limit, for the agent to be detected, is in the vicinity of parts per trillion (ppt) of concentration of the agent. Thus, the possibility of conducting measurements under real conditions without additional expenditure exists, for example at room temperature in a normal atmosphere or inside the body of a living organism. Long-term measurements for the continual monitoring of concentrations of certain agents in gases and/or liquids can be carried out without the use of complicated equipment.

The sensor does not require any heating element and thus no temperature equalization or other special measuring conditions.

It is also conceivable that such measuring probes could be combined with other measuring probes in order to, for example through the determination of the temperature and/or humidity, be able to take these parameters into account in calculations in the measurement method according to the invention.

In addition, it is also conceivable that several such measuring probes could be combined, for example, in an array with various structural dimensions and/or substances in order to include the selective characteristics of the substances in the analysis with respect to certain agents.

Another further development could be that such sensors on supporting material could be integrated directly into the circuit of a controlled semiconductor component, such as the base or gate circuit.

Additional possibilities for using the measurement results for concentrations of certain agents occur when these results are transferred to authorized recipients over EDP networks or telecommunications systems.

### BRIEF DESCRIPTION OF THE DRAWING

The objects, features and advantages of the invention will now be illustrated in more detail with the aid of the following description of preferred embodiments, with reference to the accompanying figures in which:

FIG. 1 is a cross-sectional view of a measuring probe according to the invention showing the main structural features of the probe; and

FIG. 2 is an equivalent circuit diagram for the measuring probe according to the invention.

### DESCRIPTION OF THE PREFERRED EMBODIMENTS

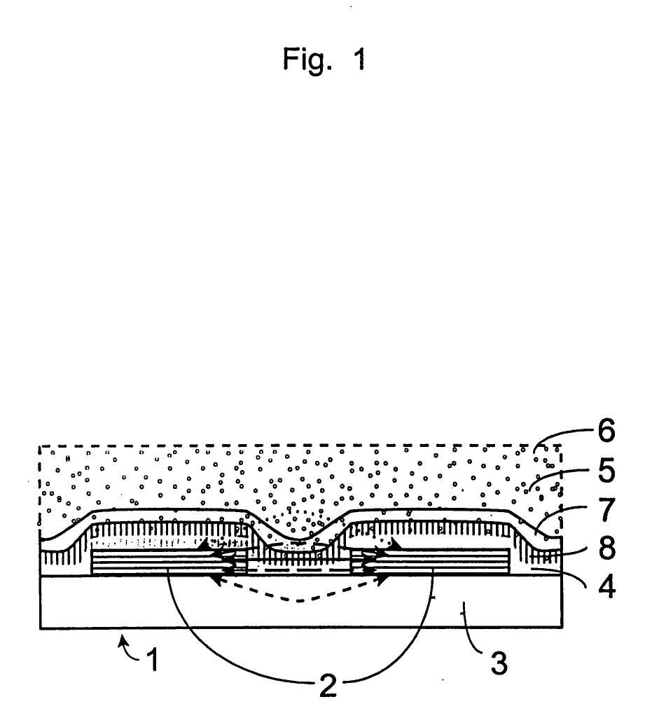

According to FIG. 1, a measuring probe 1 for agents in gases and/or liquids consists of a pair of electrodes 2, which are partially attached to a supporting material 3 and which are formed by raised sections or regions of the supporting material. A sensor-active solid layer 4 comprising a suitable solid substance is located above this surface structure. This solid layer 4 is not analyte-specific, does not absorb the agent molecules into it and does not react chemically with any of the agent molecules.

In particular this solid substance for the sensor-active solid layer 4 is an organic semiconductor in the form of a polymer, which reacts to the adsorption of certain agents 5 with a sufficient change in conductivity. The semiconductor polymer can be deposited as a polymer precursor fluid onto the surface structure, and can be tempered in-situ to yield the required polymeric species and chemical and physically functionality. A precursor, poly-2,5-furylene-hydroxy-ethylene for instance, is coated on the pair of electrodes 2 on the supporting material 3 and converted to various poly-2,5-furylene-vinylene derivatives by special heat treatment under inert atmosphere. The resulting layer resistances are extremely high, of the order of up to >10¹⁵ Ω, which corresponds to a very good insulator.

Further examples of useable polymers for the substance 4 are epoxy resins and silicones. These materials can be directly coated onto the surface of the pair of electrodes 2.

The agents 5 to be analyzed are in a gaseous state 6, which expands as an environment for the measuring probe 1 around the surface of the measuring probe 1 as a first example. There is also a covering film 7 located between the surface structure of the measuring probe 1 and the gaseous state 6. The film consists of water and the film forms due to the finite humidity of the gaseous state 6. Due to the mutual interaction of the substance 4 and the covering film 7 of water, a more effective active surface 8 is formed for measuring conductivity changes. Molecules of the agent 5 in the gaseous state 6 are adsorbed on the surface of the substance 4 and on the molecules of the covering film 7 and at these locations they replace water molecules and change the total conductivity of the sensor. In this way the non-invasive detection of volatile compounds and their concentrations in human breath or on the skin is realizable. The described measuring probe 1 can detect ppb (parts per billion) amounts of agents like acetone, ethanol, thymol, hydrogen peroxide, ammonia and hydrocarbons. The humidity might be measured simultaneously.

In another example for the same measuring probe 1, the agents 5 to be analyzed are in a liquid state 6, which spreads around the measuring probe (1) and its surface as an environment for the measuring probe 1. The structure of the measuring probe for this embodiment is the same as for the measuring probe for the gaseous phase measurements as shown in FIG. 1. In the case that the liquid is an oily liquid, the covering film 7 located on the surface structure of the measuring probe 1 can consist of water too. This active covering film 7 can be formed in advance of the measurement.

The selection of the liquid for the covering film 7 for measurements in certain liquid mediums depends on their chemical and physically properties. As the liquid for the covering film 7 one must select a liquid, which does not react with the liquid to be analyzed, which is not soluble therein and which adheres to the surface of the solid layer 4.

Molecules of the agent 5 to be detected are adsorbed on the surface of the sensor-active solid layer 4 and also by molecules of the covering film 7 in every analysis as previously described. Due to the mutual interaction of the solid layer 4 and the liquid layer acting as covering film 7, a more effective active surface 8 for detecting conductivity changes is formed. The change of total conductivity arises and is measured by a Keithley electrometer for instance.

The determination of the agents and their concentration is made in relationship to the value of the total conductivity of the measurement probe 1 in a pure liquid, past prior calibration.

Measurements in flowing liquids would permit continuously detecting and recording agent concentration changes without any dosimeter-effect. With the measuring probe 1 the water-quality can be continuously monitored for instance. Detergents, toxic substances and other materials like heavy metals can be detected and their concentrations measured.

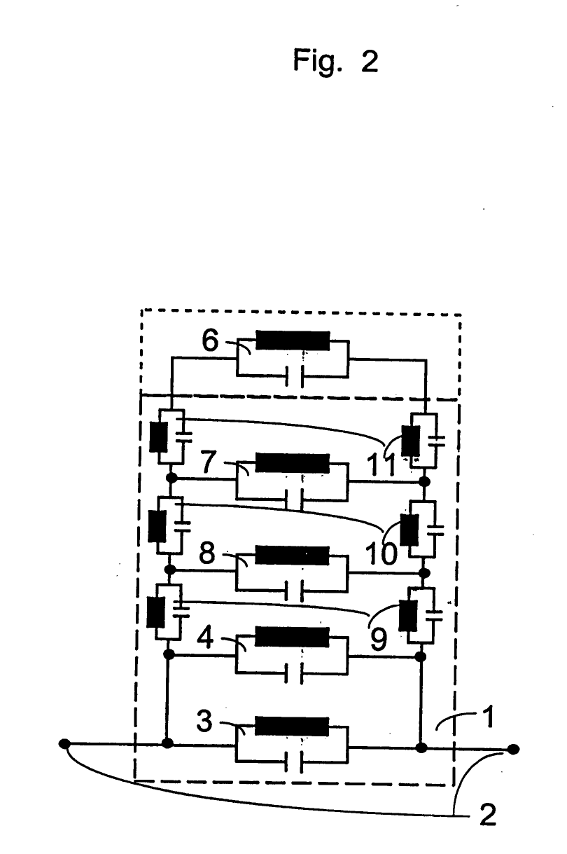

According to FIG. 2, an equivalent circuit diagram can be assumed for the individual layers and thickness of the measuring probe in the form of a resistance network, which represents the measuring probe as an electrical dipole in a permissible measurement window. Such an equivalent circuit diagram is used primarily as the basis of the calibration of the measuring probe 1 and, based on this, of the determination of the concentration of the agents 5 to be analyzed. In particular, this allows a non-linear representation by fiducial values, which are essentially independent of one another and correlate strongly with the design of the measuring probe. By using complex equivalent variables in the form of resistances, the behavior in the electrically oscillating field is also described. A parallel connection between an effective resistance and a reactive impedance characterizes the layer resistances for the supporting material 3, the solid layer 4, the active surface 8, the covering film 7 of water, the gaseous state 6 and an equivalent resistance 19, which is essentially dependent on the thickness of the electrodes 2 and the solid layer 4; an equivalent resistance II 10, which is essentially dependent on the thickness of the active surface 8 and an equivalent resistance III 11, which is essentially dependent on the characteristics of the covering film 7. The thickness of the covering film 7 consisting of, for example, water is essentially dependent on the temperature. The individual layer resistances are connected in parallel and the equivalent resistances 9, 10, 11 are arranged on both sides between the layer resistances of substance 4, the active surface 8, of the covering film 7 and the gaseous state 6.

Using conventional measurement and evaluation units, like an electrometer type 602 by Keithley Instruments for instance, the change of the total conductivity of the sensor is registered through lines from the electrodes 2 and the change is recorded and evaluated to determine the agents and their concentrations.

Arrangements including the measuring probe 1, electrometer, amplifier, controller, data memory and computer with software can be used for automated measurements and monitoring purposes.

While the invention has been illustrated and described as embodied in a measuring probe for detecting agents and the measurement of their concentrations, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

1. A measuring probe (1) for detecting agents in a gaseous medium and/or liquid medium and/or for measuring concentrations of said agents in said gaseous and/or said liquid medium, said measuring probe comprising
a non-analyte-specific sensor-active solid layer (4) which reacts to adsorption of agent molecules on said sensor-active solid layer (4) from a gas or a liquid medium by changing electrical properties of the sensor-active solid layer (4), but which is not analyte-specific, does not absorb the agent molecules into the solid layer (4) and does not react chemically with any of the agent molecules within the solid layer (4), said agent molecules being contained in said gas or said liquid medium;
a liquid covering film (7) on said sensor-active solid layer (4) formed from said gas or consisting of a selected liquid, said liquid covering film (7) being arranged between said gas or said liquid medium and said sensor-active solid layer (4) so as to cover said sensor-active solid layer (4); and
a plurality of electrodes (2) arranged in contact with said sensor-active solid layer (4) for electrical measurement of changes in said electrical properties of said sensor-active solid layer (4) due to presence of said agent molecules in said gas or said liquid medium.

2. The measuring probe (1) as defined in claim 1, wherein said sensor-active solid layer (4) consists of an organic semiconductor polymer.

3. The measuring probe (1) as defined in claim 1, wherein said sensor-active solid layer (4) is made by a method comprising coating a pair of said electrodes (2) with poly-2,5-furylene-hydroxyethylene and then performing a heat treatment under insert atmosphere.

4. The measuring probe (1) as defined in claim 1, wherein said sensor-active solid layer (4) consists of an epoxy resin or a silicone.

5. The measuring probe (1) as defined in claim 1, wherein said covering film (7) consists of water and said gas is a mixture of air and water.

6. The measuring probe (1) as defined in claim 1, further comprising means for electrical connection to a control circuit of a semiconductor component.

7. The measuring probe (1) as defined in claim 1, not including a heating element for adjusting measurement temperatures.

8. The measuring probe (1) as defined in claim 1, wherein said electrical properties include electrical conductance.

9. An array of measuring probes (1) having predetermined geometrical dimensions and electrode structures, said electrode structures comprising electrodes (2) made of different substances; wherein at least two of said measuring probes (1) each comprise a non-analyte-specific sensor-active solid layer (4) which reacts to adsorption of agent molecules from a gas or liquid medium containing the agent molecules by changing electrical properties of the sensor-active solid layer (4), a liquid covering film (7) arranged between said gas or liquid medium and said sensor-active solid layer (4) so as to cover said sensor-active solid layer (4), said liquid covering film (7) being formed from said gas or consisting of a selected liquid; and a plurality of said electrodes (2) arranged in contact with said sensor-active solid layer (4) for electrical measurement of changes in said electrical properties of the sensor-active solid layer (4) due to presence of said agent molecules in said gas or liquid medium.

10. The array of the measuring probes (1) as defined in claim 9, wherein said sensor-active solid layer (4) consists of an organic semiconductor polymer.

11. The array of the measuring probes (1) as defined in claim 9, wherein said sensor-active solid layer (4) consists of an epoxy resin or a silicone.

12. The array of the measuring probes (1) as defined in claim 9, wherein said covering film (7) consists of water and said gas is a mixture of air and water.
